(19) United States
(12) Patent Application Publication
(10) Pub. No.: US 2007/0098251 A1
(43) Pub. Date: May 3, 2007

(54) Non-contact three-dimensional measuring methods and apparatuses

(75) Inventor: Cunwei Lu, Fukuoka (JP)

Correspondence Address: JORDAN AND HAMBURG LLP, 122 EAST 42ND STREET, SUITE 4000, NEW YORK, NY, 10168, US

(73) Assignees: School Juridical Person of Fukuoka Kogyo Daigaku, Fukuoka-shi (JP); MATSUNO DESIGN TENPO KENTIKU CO., LTD., Fukuoka-shi (JP)

(21) Appl. No.: 10/581,478

(22) PCT Filed: Dec. 1, 2004
(86) PCT No.: PCT/JP04/17839

§ 371 Date: Jun. 1, 2006

(30) Foreign Application Priority Data
Dec. 3, 2003 (JP) 2003-404896

(51) Int. Cl. G06K 9/00

(52) U.S. Cl. 382/154

(57) ABSTRACT

[Problem] To determine the length, area or volume of the whole or some specified portion of various architectural structures by using simple apparatus and operation. [Solution] An object is photographed from vertically spaced multiple points by using a digital camera and the length between multiple measured points on the object in multiple photographed images or the area or volume of a portion thereof surrounded by said measured points is determined based on the position of the multiple measured points on the object in the multiple images and the heights of said multiple photographing points. A digital camera is mounted on a pan head on a tripod to photograph an object from multiple positions by vertically moving the pan head, multiple photographed images and level information of multiple photographing points are input to a computer, and the computer performs computation by clicking multiple measured points on the object in one of said multiple images. [Effect] The apparatus is inexpensive and easy to operate and the present invention is very effective for uses not particularly requiring high accuracy.

### TECHNICAL FIELD

The present invention relates to a simple and easy-to-use non-contact three-dimensional measuring method and apparatus for determining the length, area or volume of the whole or some specified part of buildings, towers and other various architectural structures by means of photographed images.

### BACKGROUND ART

A conventional non-contact three-dimensional measuring method is based on stereo vision technique. This method takes two or more photographs of the object to be measured and determines the three-dimensional coordinates of the measuring point by using triangulation or other location-determining principle on computers. On civil engineering and other construction sites, optical triangulation method employing a measuring device equipped with a telescope and a red-and-white banded rod are still in wide use.

Patent Document No. 1 discloses a method for determining the three-dimensional position of the target point by freely rotating a digital camera equipped with a device to obtain position direction information and taking photographs of the target point from randomly chosen two points. It is described that the method permits simple determination of the three-dimensional position of many target points with high accuracy.

Patent Document No. 1: Japanese Unexamined Patent Publication No. 2001-336930

### DISCLOSURE OF THE INVENTION

### Problem to be Solved by the Invention

In order to calculate the three-dimensional coordinates of the point to be measured, the conventional three-dimensional image measuring methods take multiple photographs of the object to be measured. It is, however, difficult to quickly derive the result of measurement for different objects because camera position is limited and the space position of camera has great effect on the result of measurement. The conventional techniques have sometimes disabled measurement because of the difficulty in identifying the measured point in multiple images that, in turn, takes too much time to permit automatic measurement.

The technique described in said patent document involved a problem that the mechanism to realize free rotation of the digital camera is complicated and costly.

Now the present invention provides a simple and easy-to-use non-contact three-dimensional measuring method and apparatus for determining the length, area or volume of the whole or some specified part of buildings, towers and other various architectural structures by means of photographed.

### MEANS FOR SOLVING THE PROBLEM

The non-contact three-dimensional measuring method according to the present invention takes photographs of an object from vertically spaced multiple points by using a digital camera and determines the length between multiple measured points on the object in multiple photographed images or the area or volume of a portion thereof surrounded by said measured points based on the position of the multiple measured points on the object in the multiple images and the heights of said multiple photographing points.

The method of the present invention mounts a digital camera on a pan head on a tripod, photographs an object from multiple positions by vertically moving the pan head, inputting multiple photographed images and level information of multiple photographing points to a computer, and makes the computer perform computation by clicking multiple measured points on the object in one of said multiple images.

The non-contact three-dimensional measuring apparatus according to the present invention comprises a digital camera to take photographs of an object, a device to vertically move and fasten said camera at desired photographing points, a computer to determine the length between multiple measured points on the object or the area or volume of a portion thereof surrounded by said measured points based on the level information of said multiple photographing points and multiple photographed images, and a display attached to said computer for displaying said images and instructing the start of computation by clicking said measured points.

In the apparatus described above, the device to vertically move and fasten the camera may be a combination of a tripod and a pan head.

### EFFECT OF THE INVENTION

The present invention permits determining the length, area or volume of the whole or some specified portion of buildings, towers and other various architectural structures by using simple apparatus and operation. The apparatus is inexpensive, photographing is performed at the measuring site by using a digital camera and a combination of a pan head and a tripod, photographed image data is sent to a computer that derives measurements by easy operation. Thus, the present invention is very effective for uses not particularly requiring high accuracy.

### BEST MODE FOR PRACTICING THE INVENTION

The measuring method according to the present invention first takes photographs of an object 6 from vertically spaced multiple points by using a digital camera 1 as shown in FIG. 1. The digital camera 1 may be mounted on a pan head 3 that is vertically movable at the top of a tripod 3 as shown in this example.

Next, photographed multiple images and information concerning multiple photographing points are input to a computer 4. In this example, heights H₁ and Hₙ from the reference plane of the tripod 2 to the camera 1 are input to the computer 4 as the information concerning the photographing points.

The computer 4 determines the length, area or volume for the desired measured points on the object 6. In the example shown in FIG. 1 in which points A, B, C and D were determined, the length of a line AB, the area of a triangle ABC or the volume of a pyramid surrounded by points A, B, C, D and another point at the back can be determined based on measured points A₁, B₁, C₁ and D₁ on an image taken by the camera at height H₁ shown in FIG. 2 and measured points Aₙ, Bₙ, Cₙ and Dₙ on an image taken by the camera at height Hₙ shown in FIG. 3.

The computer 4 performs computation when the desired measured points A₁, B₁, . . . on the object in the reference image, which is, for example, the image shown in FIG. 2 chosen from the multiple images photographed, are clicked on a display 5 attached to the computer 4. The computer 4 is programmed to automatically recognize the measured points Aₙ, Bₙ, . . . on other images than the reference image.

When the measured points are clicked on the reference image, the measured spot can be enlarged to the desired magnification.

Based on the height information of multiple photographing points (H₁, Hₙ) and the positions of the desired measured points (A₁, B₁, . . . , Aₙ, Bₙ, . . . ) on the object in multiple images as shown in FIGS. 2 and 3, the computer 4 determines the three-dimensional coordinates of each measured point according to the principle of triangulation and derives the length, area or volume of the desired portion from the obtained three-dimensional coordinates.

The obtained three-dimensional coordinates and the length, area and volume are relative values (such as length ratio) which can be converted to absolute values (such as m) by inputting the distance between the camera 1 and object 6 or the actual size of a specific portion of the object 6.

When the object 6 is photographed with the digital camera 1 according to the method of the present invention, photographing conditions such as zooming, focus, shutter speed, sensitivity and white balance are not changed at the individual shooting positions. It is also preferable that camera position is moved up and down along the same vertical line and the photographing angle of the camera is fixed.

The photographed images may be output to the display 5 by connecting the memory to the computer 4 or by transmitting to the computer 4.

When the desired measured points A₁, B₁, C₁ and D₁ on the reference image, such as, for example, the image shown in FIG. 2 are clicked, the computer 4 recognizes a small area centered around each measured point as the decision area. In other images than the reference image, such as the image shown in FIG. 3, the computer automatically selects a small area of the same size that corresponds to the decision area in the reference image. By scanning the selected area and comparing the color histogram of the selected area with that of the decision area in the reference image, the computer determines the center points of the most analogous selected area as the measured points Aₙ, Bₙ, Cₙ and Dₙ of the image.

The computer derives the desired length, area and volume data by determining the three-dimensional coordinates of the measured points A, B, C and D of the object 6 from the measured points A₁, B₁, C₁ and D₁ and Aₙ, Bₙ, Cₙ and Dₙ on the two images and camera heights H₁ and Hₙ at which the images were taken, according to the principle of triangulation.

The results of computation by the computer 4 may be displayed on the display 5 or output to a printer.

The apparatus according to the present invention, which implements the method of the present invention, comprises a digital camera 1, a tripod 3, a device to vertically move and fasten the camera, such as a pan head 3, a computer 4 and a display 6 attached to the computer 4, as illustrated in FIG. 1. The computer performs the computation described earlier and determines the length, area or volume for the desired measured points A₁, B₁ . . . .

### EXAMPLE

By mounting the digital camera 1 on the pan head 3 at the top of the tripod 1, a building, which was the object 6, was photographed and points A, B, C and D of the pyramidal roof thereof were determined. The digital camera 1 was positioned at two levels. By vertically moving the pan head 3, photographs were taken with the camera 1 positioned at heights H₁ and H₂ from the reference plane of the tripod 2. The distance H₂−H₁ was 300 mm and the distance between the digital camera 1 and object 6 was 20 m.

The image (FIG. 2) taken at camera height H₁ was selected as the reference image and the distance between the individual points A, B, C and D, the area of the triangle and the volume of the pyramid were output by clicking the measured points A₁, B₁, C₁ and D₁ on the display 5. Then, the following were obtained.

Lengths: AB=1400 mm, AC=1397 mm, AD=1401 mm, BC=802 mm, CD=398 mm

Area of triangle: ABC=537,247 mm², ACD=275,556 mm²

Volume of equilateral pyramid surrounded by points A, B, C and D and a point at the back: 143×10⁶ mm³

### BRIEF DESCRIPTION OF THE DRAWINGS

FIG. 1 is a schematic drawing showing the main component members of the present invention.

FIG. 2 is an example of the image according to the present invention.

FIG. 3 is another example of the image according to the present invention.

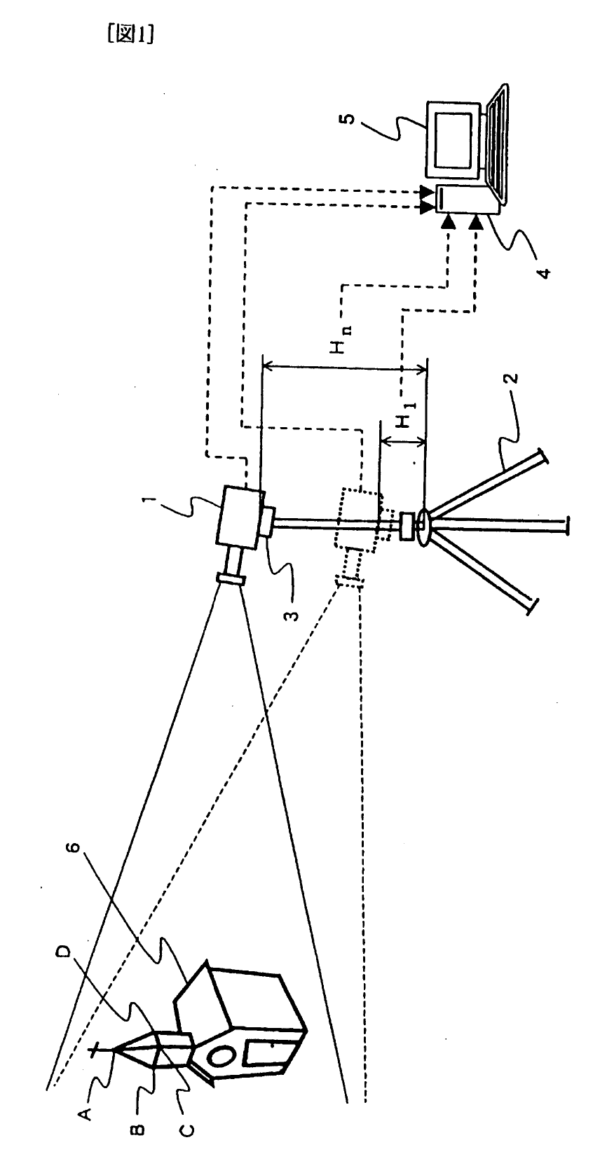

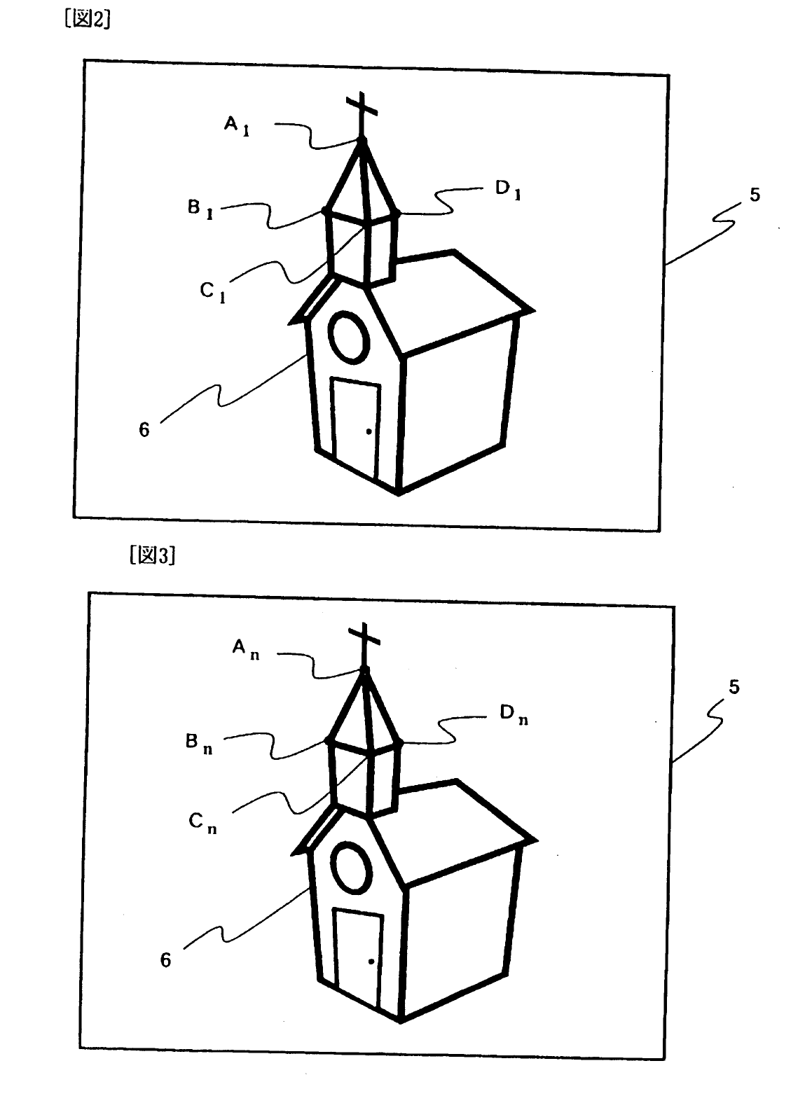

### EXPLANATION OF REFERENCE CHARACTERS

1: Digital camera

2: Tripod

3: Pan head

4: Computer

5: Display

6: Object

A, B, C, D: Measured points

H: Height

What is claimed is:

1. A non-contact three-dimensional measuring method comprising photographing an object with a digital camera from vertically spaced multiple points and determining the length between multiple measured points or the area or volume of a portion surrounded by said multiple measured points based on the position of the multiple measured points on the object in photographed multiple images and the height difference between said multiple photographing points.

2. The A non-contact three-dimensional measuring method described in claim 1, in which a digital camera is mounted on a pan head at the top of a tripod, an object is photographed with the digital camera from multiple points obtained by vertically moving the pan head, the photographed multiple images and height information of the multiple photographing points are input to a computer, and the computer performs computation by clicking the multiple measured points on the object in one of said multiple images shown on a display attached to the computer.

3. A non-contact three-dimensional measuring apparatus comprising a digital camera to take photographs of an object, a device to vertically move and fasten said camera at desired photographing points, a computer to determine the length between multiple measured points on the object or the area or volume of a portion thereof surrounded by said measured points based on the level information of said multiple photographing points and multiple photographed images, and a display attached to said computer for displaying said images and instructing the start of computation by clicking said measured points.

4. The non-contact three-dimensional measuring apparatus described in claim 3, in which the device to vertically move and fasten the camera comprises a tripod and a vertically movable pan head.
